(19) United States
(12) Patent Application Publication
(10) Pub. No.: US 2012/0001122 A1
(43) Pub. Date: Jan. 5, 2012

(54) USE OF HOLLOW BODIES FOR PRODUCING WATER-ABSORBING POLYMER STRUCTURES

(76) Inventors: Laurent Wattebled, Dusseldorf (DE); Rainer Teni, Moers (DE); Jorg Harren, Baesweiler (DE)

(21) Appl. No.: 13/201,780

(22) PCT Filed: Mar. 9, 2010
(86) PCT No.: PCT/EP2010/052931

§ 371 Date: Sep. 23, 2011

(30) Foreign Application Priority Data
Apr. 7, 2009 (DE) 102009016404.9

(51) Int. Cl. C09K 3/00; C09K 17/22

(52) U.S. Cl. 252/194

(57) ABSTRACT

The present invention relates to water-absorbing polymer structures at least partly comprising hollow bodies with a shell of an inorganic or organic material. The invention further relates to a process for producing water-absorbing polymer structures, to the water-absorbing polymer structures obtainable by this process, to a composite, to a process for producing a composite, to the composite obtainable by this process, to chemical products, for instance foams, moldings or fibers, to the use of water-absorbing polymer structures or of a composite in chemical products, for instance foams, moldings or fibers, and to the use of hollow bodies with a shell of an inorganic or organic material.

The present invention relates to water-absorbing polymer structures, to a process for producing water-absorbing polymer structures, to the water-absorbing polymer structures obtainable by this process, to a composite, to a process for producing a composite, to the composite obtainable by this process, to chemical products, for instance foams, moldings or fibers, to the use of water-absorbing polymer structures or of a composite in chemical products, for instance foams, moldings or fibers, and to the use of hollow bodies with a shell of an inorganic or organic material.

Superabsorbents are water-insoluble crosslinked polymers which are capable of absorbing large amounts of aqueous liquids, especially body fluids, preferably urine or blood, with swelling and formation of hydrogels, and of retaining them under pressure. In general, these liquid absorptions are at least 10 times or even at least 100 times the dry weight of the superabsorbents or of the superabsorbent compositions of water. By virtue of these characteristic properties, these polymers find use principally in sanitary articles such as diapers, incontinence products or sanitary napkins A comprehensive overview of superabsorbents and superabsorbent compositions, the use thereof and the production thereof is given by F. L. Buchholz and A. T. Graham (editors) in “Modern Superabsorbent Polymer Technology,” Wiley-VCH, New York, 1998.

The superabsorbents are prepared generally by the free-radical polymerization of usually partly neutralized monomers bearing acid groups, in the presence of crosslinkers. Through the selection of the monomer composition, of the crosslinkers and of the polymerization conditions, and of the processing properties for the hydrogel obtained after the polymerization, it is possible to prepare polymers with different absorption properties. Further possibilities are offered by the preparation of graft polymers, for example using chemically modified starch, cellulose and polyvinyl alcohol according to DE-A-26 12 846.

The current trend in diaper construction is to produce even thinner constructions with reduced cellulose fiber content and increased superabsorbent content. The advantage of thinner constructions is exhibited not just in improved wear comfort but also in reduced costs in packaging and storage. With the trend toward ever thinner diaper constructions, the profile of requirements on the superabsorbents has changed significantly. Of crucial significance is now the ability of the hydrogel to conduct and distribute the liquid. Owing to the higher loading of the hygiene article (amount of superabsorbent per unit area), the polymer in the swollen state must not form a barrier layer for subsequent liquid (gel blocking) If the product has good transport properties, optimal exploitation of the overall hygiene article can be ensured.

In addition to the permeability of the superabsorbents (reported in the form of the so-called “Saline Flow Conductivity—SFC”) and the absorption capacity under compressive stress, the absorption rate of the superabsorbent particles in particular (reported in amount of liquid absorbed per gram of superabsorbent per second) is also a crucial criterion which enables statements about whether an absorbent core which comprises this superabsorbent in a large concentration and has only a low fluff content is capable, on its first contact with liquids, of absorbing them rapidly (so-called “first acquisition”). In the case of absorbent cores with a high superabsorbent content, this “first acquisition” depends, among other factors, on the absorption rate of the superabsorbent material.

In order to improve the absorption rate of superabsorbents, the prior art discloses various approaches. For instance, the surface area of the superabsorbent can be increased by using smaller superabsorbent particles with a correspondingly higher surface-volume ratio. The result of this, however, is that the permeability and also other performance characteristics, for example the retention, of the superabsorbent are reduced. In order to avoid this problem, an increase in the surface area of the superabsorbent particles can also be achieved without reducing the particle diameter by, for example, producing superabsorbent particles with irregular shapes by pulverizing. For example, U.S. Pat. No. 5,118,719 and U.S. Pat. No. 5,145,713 also disclose dispersing blowing agents in the monomer solution during the polymerization, which release carbon dioxide in the course of heating. The porosity of the resulting superabsorbent provides a relatively large surface area in the polymer particles, which ultimately enables an increased absorption rate. U.S. Pat. No. 5,399,391 further discloses postcrosslinking such foamed superabsorbent particles on the surface, in order also to improve the absorption capacity under compressive stress in this way. However, the disadvantage of this approach is that, owing to the large surface area of the foamed superabsorbent particles, it is necessary to use the surface crosslinkers in an even greater amount compared to unfoamed superabsorbent particles, which inevitably also leads to an increased crosslinking density in the surface region. Too high a crosslinking density in the surface regions leads, however, to a reduction in the absorption rate. Furthermore, the use of blowing agents is disadvantageous in that the amount of gas formed in the monomer solution, in the case of use of carbonates, depends greatly on the temperature and the pH during the polymerization. Furthermore, blowing agents in the monomer solution tend to agglomerate to form relatively large gas bubbles, such that the ultimate porosity of the superabsorbent material can be controlled only with difficulty. In the case of use of carbonates too, the residence time in the monomer solution and especially also the exact time of release of the carbon dioxide can be regulated only with difficulty.

It was an object of the present invention to overcome the disadvantages which arise from the prior art in connection with the production of water-absorbing polymer structures with high absorption rate.

More particularly, it was an object of the present invention to provide water-absorbing polymer structures which can be used particularly efficiently in hygiene articles with high superabsorbent content. The water-absorbing polymers should, in addition to an advantageously high absorption rate, have a particularly high absorption under compressive stress, a particularly high retention and a particularly high permeability.

It was also an object of the present invention to specify a process for producing water-absorbing polymer structures, with which it is possible to produce polymers with the above-described absorption properties in an efficiently reproducible manner. Moreover, the polymer particles obtained after the drying of the polymer gel by this process, after performance of surface postcrosslinking, should have a noticeably lower decline in the absorption rate than is the case for conventional water-absorbing polymer structures.

A contribution to the achievement of the objects cited at the outset is made by water-absorbing polymer structures at least partly comprising hollow bodies with a shell of an inorganic or organic material.

The term “hollow body” as used herein is preferably understood quite generally to mean spherical structures which have a shell of an inorganic or organic material, which includes a blowing agent. According to the invention, a “blowing agent” is preferably understood to mean compounds which are at least partly, preferably entirely, gaseous at atmospheric pressure and at a temperature within a range from −50 to 100° C., more preferably within a range from 0 to 50° C. and most preferably within a range from 20 to 40° C. Such blowing agents include, for example, gases, for instance air, or else liquids such as short-chain hydrocarbons.

In a preferred embodiment of the inventive water-absorbing polymer structures, the latter comprise the hollow bodies in an amount within a range from 0.001 to 15% by weight, more preferably within a range from 0.01 to 7.5% by weight and most preferably within a range from 0.1 to 3% by weight, based in each case on the total weight of the inventive water-absorbing polymer structures.

Water-absorbing polymer structures preferred in accordance with the invention are fibers, foams or particles, preference being given to fibers and particles, and particular preference to particles.

The dimensions of polymer fibers preferred in accordance with the invention are such that they can be incorporated into or as yarns for textiles and also directly into textiles. It is preferred in accordance with the invention that the polymer fibers have a length in the range from 1 to 500 mm, preferably 2 to 500 mm and more preferably 5 to 100 mm, and a diameter in the range from 1 to 200 denier, preferably 3 to 100 denier and more preferably 5 to 60 denier.

The dimensions of polymer particles preferred in accordance with the invention are such that they have a mean particle size to ERT 420.2-02 in the range from 10 to 3000 μm, preferably 20 to 2000 μm and more preferably 150 to 850 μm. It is especially preferred that the proportion of the polymer particles with a particle size within a range from 300 to 600 μm is at least 30% by weight, more preferably at least 40% by weight and most preferably at least 50% by weight, based on the total weight of the water-absorbing polymer particles.

It is additionally preferred in accordance with the invention that the inventive water-absorbing polymer structures are based on partly neutralized, crosslinked acrylic acid. In this context, it is especially preferred that the inventive water-absorbing polymer structures are crosslinked polyacrylates which consist to an extent of at least 50% by weight, preferably to an extent of at least 70% by weight and further preferably to an extent of at least 90% by weight, based in each case on the weight of the water-absorbing polymer structures, of monomers bearing carboxylate groups. It is additionally preferred in accordance with the invention that the inventive water-absorbing polymer structures are based to an extent of at least 50% by weight, preferably to an extent of at least 70% by weight, based in each case on the weight of the water-absorbing polymer structures, on polymerized acrylic acid, which is preferably neutralized to an extent of at least 20 mol %, more preferably to an extent of at least 50 mol % and further preferably within a range from 60 to 85 mol %.

Useful inorganic materials of which the shell of the hollow bodies consists are, for example, polycrystalline oxides, especially polycrystalline aluminum oxides, while preferred organic materials are especially polymeric thermoplastic or non-thermoplastic materials.

According to the invention, hollow bodies with a shell of an organic material are preferably understood to mean hollow bodies selected from the following group:
hollow bodies which have a shell of a polymeric thermoplastic material;
hollow bodies which have a shell of a polymeric non-thermoplastic material.

Generally, the hollow bodies used may be
gas-filled microballoons based on thermoplastic or non-thermoplastic polymers,
polyelectrolyte multilayer capsules,
hollow spheres based on thermoplastic or non-thermoplastic polymers,
microsphere particles based on thermoplastic polymers, as obtainable, for example, under the “EXPANCEL®” trade name, or
hollow bodies with a shell of polycrystalline aluminum oxide.

According to the invention, a hollow body which has a shell of a polymeric thermoplastic material is preferably understood to mean a hollow body which is obtainable by heating a polymeric thermoplastic material which includes a material which increases its volume (=blowing agent) in the event of a temperature increase. These hollow bodies therefore have a shell of a polymeric thermoplastic material which includes a blowing agent. One example of such a polymeric thermoplastic material is, for example, the microsphere particles obtainable under the “EXPANCEL®” brand from Akzo Nobel, Sundsvall, Sweden, the production of which is described in WO-A-2007/142593 among other documents. The blowing agent is preferably a compound whose boiling point is not higher than the melting or glass transition temperature of the polymeric thermoplastic material.

Such polymeric thermoplastic materials including a blowing agent can be obtained, for example, by free-radically polymerizing the monomers used to prepare the polymeric thermoplastic polymer in a suspension polymerization in the presence of a suitable blowing agent, for example isobutane, and optionally in the presence of crosslinkers. One such process is described in detail in WO-A-2007/142593. The publications U.S. Pat. No. 3,615,972, U.S. Pat. No. 3,945,956, U.S. Pat. No. 4,287,308, U.S. Pat. No. 5,536,756, U.S. Pat. No. 6,235,800, U.S. Pat. No. 6,235,394, U.S. Pat. No. 6,509,384, USA-2004/0176486, US-A-2005/0079352, GB 1024195, EP-A-0 486 080, EP-A-1 288 272, WO-A-2004/072160, JP-A-1987-286534, JP-A-2005-213379 and JP-A-2005-272633 also disclose processes for producing such materials.

The polymeric thermoplastic materials used may in principle be all polymeric thermoplastic materials known to the person skilled in the art, a “polymeric thermoplastic material” in accordance with the invention preferably being understood to mean a polymeric material which can be plastically deformed with supply of heat. In this context, it is especially preferred in accordance with the invention that the polymeric thermoplastic material has a melting or glass transition temperature determined by dynamic scanning calorimetry (DSC) within a range from 40° C. to 240° C., more preferably 60° C. to 220° C. and most preferably 80 to 200° C.

Polymeric thermoplastic materials which are suitable in accordance with the invention and have the hollow bodies present in the inventive water-absorbing polymer structures as a shell are especially polymers selected from the group consisting of poly(meth)acrylates, (meth)acrylic acid copolymers, for example ethylene-(meth)acrylic acid copolymers, (meth)acrylic ester copolymers, maleic acid copolymers, for example maleic acid-propylene copolymers, polyurethanes, vinyl acetate copolymers, for example an ethylene-vinyl acetate copolymer or vinyl acetate-butyl acrylate copolymer, styrene copolymers, for example butyl acrylate-styrene copolymers, polycarbonates and polyvinyl alcohols. Suitable in accordance with the invention are especially
hollow bodies whose polymeric thermoplastic material is based on acrylonitrile and vinyl ethers, as described, for instance, in WO-A-2007/142593, where the vinyl ethers used may especially be vinyl ethers selected from the group consisting of methyl vinyl ether, ethyl vinyl ether, propyl vinyl ether, isopropyl vinyl ether, butyl vinyl ether, isobutyl vinyl ether, tert-butyl vinyl ether, sec-butyl vinyl ether and mixtures thereof, where the copolymers of acrylonitrile and of vinyl ether may optionally also be crosslinked by the use of crosslinkers, for instance divinylbenzene, ethylene glycol di(meth)acrylate or of other crosslinkers specified in WO-A-2007/142593;
hollow bodies whose polymeric thermoplastic material is based on acrylonitrile, methacrylonitrile, acrylic esters and methacrylic esters, as described, for instance, in WO-A-2007/091961 or in WO-A-2007/091960, which polymers may optionally also be crosslinked by the use of the crosslinkers described in WO-A-2007/091961 or in WO-A-2007/091960;
hollow bodies whose polymeric thermoplastic material is based on polyvinylidene chloride, for instance the products obtainable under the EXPANCEL® trade name from Akzo Nobel.

Preferably included in the hollow bodies with the shell of the polymeric thermoplastic material is a blowing agent which is at least partly present as a gas at atmospheric pressure and at a temperature within a range from −50 to 100° C., more preferably within a range from 0 to 50° C. and most preferably within a range from 20 to 40° C. This blowing agent is preferably a hydrocarbon, for example a hydrocarbon selected from the group consisting of methane, ethane, propane, n-butane, isobutane, n-pentane, isopentane, neopentane, cyclopentane, hexane, isohexane, neohexane, cyclohexane, heptane, isoheptane, octane, isooctane and isododecane, petroleum ether or halogenated hydrocarbons, for example halogenated hydrocarbons selected from the group consisting of methyl chloride, methylene chloride, dichloroethane, dichloroethylene, trichloroethane, trichloroethylene, trichlorofluoromethane and perfluorinated hydrocarbons, for instance fluorine-containing ethers. Water may also serve as a blowing agent. The boiling point of the blowing agent at atmospheric pressure is preferably in the range from −50 to 100° C., more preferably 0 to 50° C. and most preferably 20 to 40° C. However, it is also conceivable in principle to use hollow bodies with a shell of a polymeric thermoplastic material filled with air.

In addition to the above-described hollow bodies, it is also possible to use gas-filled microballoons, polyelectrolyte multilayer capsules or hollow spheres filled with gaseous or liquid compounds, it being possible for the microballoons and the hollow spheres to be based either on thermoplastic polymers or on non-thermoplastic polymers as the shell material.

Examples of gas-filled microballoons are, for instance, microballoons which consist of a shell of a crosslinked polyvinyl alcohol. Such microballoons are described, for example, in Cavalieri et al., “Stable Polymeric Microballoons as Multifunctional Device for Biomedical Uses: Synthesis and Characterization”, LANGMUIR 2005 (Vol. 21 (19)), pages 8.758-8.764. Examples of suitable polyelectrolyte multilayer capsules include those capsules described in Heuvingh et al., “Salt softening of polyelectrolyte multilayer capsules”, LANGMUIR 2005 (Vol. 21 (7)), pages 3.165-3.171. Examples of hollow spheres suitable in accordance with the invention are, for example, the products which are sold by Rohm & Haas, France, under the ROPAQUE® name, for example ROPAQUE® ULTRA E Opaque Polymer, and which are described in EP-A-1 757 639. In these products, a liquid (water) is enclosed by a polymer shell, the liquid being able to pass through the polymer membrane as it evaporates, such that an air-filled hollow body remains.

Examples of a hollow body with a shell of an inorganic material include the particles which are based on polycrystalline aluminum oxide, are referred to as “bubble alumina,” and are sold under the GL®, GLHP® or Duralum® AB names by Rio Tinto Alcan, France. In a preferred embodiment of the inventive water-absorbing polymer structures, at least some of the hollow bodies are embedded in the water-absorbing polymer structure configured as a matrix, in which case it is especially preferred that the hollow bodies are distributed homogeneously in the water-absorbing polymer structures.

Such a structure is obtainable, for example, by adding the hollow body with a shell of the inorganic or organic material to the monomer solution which has been used to prepare the water-absorbing polymer structures before or during the polymerization, or else by incorporating it into the polymer gel obtained after the polymerization, it being possible in the case of use of a hollow body with a shell of a polymeric thermoplastic material to use these hollow bodies already in expanded form before their use or else in the as yet unexpanded state. The inventive water-absorbing polymer structures are therefore preferably obtainable by a process comprising the process steps of:
i) free-radically polymerizing an aqueous monomer solution comprising a polymerizable, monoethylenically unsaturated monomer bearing an acid group (α1) or a salt thereof, optionally a monoethylenically unsaturated monomer (α2) polymerizable with monomer (α1), and optionally a crosslinker (α3), to obtain a polymer gel;
ii) optionally comminuting the hydrogel;
iii) drying the optionally comminuted hydrogel to obtain water-absorbing polymer particles;
iv) optionally grinding and screening off the water-absorbing polymer particles thus obtained;
v) optionally further surface modifying the water-absorbing polymer particles thus obtained;
   where at least one of conditions I) and II), optionally also both conditions I) and II), is or are met:
I) the hollow bodies with a shell of the inorganic or organic material are added to the monomers in process step i);
II) the hollow bodies with a shell of the inorganic or organic material are incorporated into the hydrogel obtained in process step i) or into the comminuted hydrogel obtained in process step ii).

In process step i), an aqueous monomer solution comprising a polymerizable, monoethylenically unsaturated monomer bearing an acid group (α1) or a salt thereof, optionally a monoethylenically unsaturated monomer (α2) polymerizable with monomer (α1), and optionally a crosslinker (α3), is initially free-radically polymerized to obtain a polymer gel. The monoethylenically unsaturated monomers bearing acid groups (α1) may be partly or fully, preferably partly, neutralized. The monoethylenically unsaturated monomers bearing acid groups (α1) are preferably at least 25 mol %, more preferably at least 50 mol % and further preferably 50-80 mol % neutralized. In this connection, reference is made to DE 195 29 348 A1, the disclosure of which is hereby incorporated by reference. Some or all of the neutralization may also follow the polymerization. In addition, the neutralization can be effected with alkali metal hydroxides, alkaline earth metal hydroxides, ammonia, and also carbonates and bicarbonates. In addition, any further base which forms a water-soluble salt with the acid is conceivable. Mixed neutralization with different bases is also conceivable. Preference is given to neutralization with ammonia and alkali metal hydroxides, particular preference to that with sodium hydroxide and with ammonia.

Moreover, in the inventive water-absorbing polymer structures, the free acid groups may predominate, such that this polymer structure has a pH in the acidic range. This acidic water-absorbing polymer structure can be at least partly neutralized by a polymer structure with free basic groups, preferably amine groups, which is basic compared to the acidic polymer structure. These polymer structures are referred to in the literature as “Mixed-Bed Ion-Exchange Absorbent Polymers” (MBIEA polymers) and are disclosed, inter alia, in WO 99/34843 A1. The disclosure of WO 99/34843 A1 is hereby incorporated by reference and is therefore considered to form part of the disclosure. In general, MBIEA polymers constitute a composition which firstly includes basic polymer structures which are capable of exchanging anions, and secondly an acidic polymer structure compared to the basic polymer structure, which is capable of exchanging cations. The basic polymer structure has basic groups and is typically obtained by the polymerization of monomers which bear basic groups or groups which can be converted to basic groups. These monomers are primarily those which have primary, secondary or tertiary amines or the corresponding phosphines or at least two of the above functional groups. This group of monomers includes especially ethyleneamine, allylamine, diallylamine, 4-aminobutene, alkyloxycyclines, vinylformamide, 5-aminopentene, carbodiimide, formaldacine, melamine and the like, and the secondary and tertiary amine derivatives thereof.

Preferred monoethylenically unsaturated monomers bearing acid groups (α1) are preferably those compounds specified as ethylenically unsaturated monomers bearing acid groups (α1) in WO 2004/037903 A2, which is hereby incorporated by reference and is therefore considered to be part of the disclosure. Particularly preferred monoethylenically unsaturated monomers bearing acid groups (α1) are acrylic acid and methacrylic acid, acrylic acid being the most preferred.

The monoethylenically unsaturated monomers (α2) used, which are copolymerizable with the monomers (α1), may be acrylamides, methacrylamides or vinylamides. Further preferred comonomers are especially those which are specified as comonomers (α2) in WO 2004/037903 A2.

The crosslinkers (α3) used are preferably likewise those compounds specified in WO 2004/037903 A2 as crosslinkers (α3). Among these crosslinkers, particular preference is given to water-soluble crosslinkers. The most preferred are N,N′-methylenebisacrylamide, polyethylene glycol di(meth)acrylates, triallylmethylammonium chloride, tetraallylammonium chloride, and allyl nonaethylene glycol acrylate prepared with 9 mol of ethylene oxide per mole of acrylic acid.

In addition to the monomers (α1) and optionally (α2) and optionally the crosslinker (α3), the monomer solution may also include water-soluble polymers (α4). Preferred water-soluble polymers comprise partly or fully hydrolyzed polyvinyl alcohol, polyvinylpyrrolidone, starch or starch derivatives, polyglycols or polyacrylic acid. The molecular weight of these polymers is uncritical provided that they are water-soluble. Preferred water-soluble polymers are starch or starch derivatives or polyvinyl alcohol. The water-soluble polymers, preferably synthetic water-soluble polymers such as polyvinyl alcohol, can not only serve as the graft base for the monomers to be polymerized. It is also conceivable to mix these water-soluble polymers with the polymer gel only after the polymerization, or with the already dried, water-absorbing polymer gel.

In addition, the monomer solution may also comprise assistants (α5), which assistants include especially the initiators or complexing agents which may be required for the polymerization, for example EDTA.

Useful solvents for the monomer solution include water, organic solvents or mixtures of water and organic solvents, the selection of the solvent depending especially also on the manner of the polymerization.

The relative amount of monomers (α1) and (α2) and of crosslinkers (α3) and water-soluble polymers (α4) and assistants (α5) in the monomer solution (without considering the hollow bodies having the polymeric material) is preferably selected such that the water-absorbing polymer structure obtained after drying in process step iii) is based
to an extent of 20 to 99.999% by weight, preferably to an extent of 55 to 98.99% by weight and more preferably to an extent of 70 to 98.79% by weight on the monomers (α1),
to an extent of 0 to 80% by weight, preferably to an extent of 0 to 44.99% by weight and more preferably to an extent of 0.1 to 44.89% by weight on the monomers (α2),
to an extent of 0 to 5% by weight, preferably to an extent of 0.001 to 3% by weight and more preferably to an extent of 0.01 to 2.5% by weight on the crosslinkers (α3),
to an extent of 0 to 30% by weight, preferably to an extent of 0 to 5% by weight and more preferably to an extent of 0.1 to 5% by weight on the water-soluble polymers (α4),
to an extent of 0 to 20% by weight, preferably to an extent of 0 to 10% by weight and more preferably to an extent of 0.1 to 8% by weight on the assistants (α5), and
to an extent of 0.5 to 25% by weight, preferably to an extent of 1 to 10% by weight and more preferably to an extent of 3 to 7% by weight on water (α6),
   where the sum of the weights (α1) to (α6) is 100% by weight. Optimal values for the concentration, especially of the monomers, crosslinkers and water-soluble polymers, in the monomer solution can be determined by simple preliminary tests or else inferred from the prior art, especially publications U.S. Pat. No. 4,286,082, DE-A-27 06 135, U.S. Pat. No. 4,076,663, DE-A-35 03 458, DE 40 20 780 C1, DE-A-42 44 548, DE-A-43 33 056 and DE-A-44 18 818. For the free-radical polymerization of the monomer solution, useful polymerization processes are in principle all of those known to those skilled in the art. For example, mention should be made in this context of bulk polymerization, which is preferably effected in kneading reactors such as extruders, solution polymerization, spray polymerization, inverse emulsion polymerization and inverse suspension polymerization.

The solution polymerization is preferably performed in water as the solvent. The solution polymerization can be effected continuously or batchwise. The prior art discloses a broad spectrum of possible variations with regard to reaction conditions, such as temperatures, type and amount of the initiators, and the reaction solution. Typical processes are described in the following patents: U.S. Pat. No. 4,286,082, DE-A-27 06 135 A1, U.S. Pat. No. 4,076,663, DE-A-35 03 458, DE 40 20 780 C1, DE-A-42 44 548, DE-A-43 33 056, DE-A-44 18 818. The disclosures are hereby incorporated by reference and are therefore considered to form part of the disclosure.

The polymerization is triggered by an initiator, as is generally customary. The initiators used to initiate the polymerization may be all initiators which form free radicals under the polymerization conditions and are typically used in the production of superabsorbents. Initiation of the polymerization by the action of electron beams on the polymerizable aqueous mixture is also possible. The polymerization can, however, also be triggered in the absence of initiators of the type mentioned above by the action of high-energy radiation in the presence of photoinitiators. Polymerization initiators may be present dissolved or dispersed in the monomer solution. Useful initiators include all compounds which decompose to free radicals and are known to the person skilled in the art. These include especially those initiators which are already mentioned in WO-A-2004/037903 as possible initiators. Particular preference is given to producing the water-absorbing polymer structures using a redox system consisting of hydrogen peroxide, sodium peroxodisulphate and ascorbic acid.

Inverse suspension and emulsion polymerization can also be employed to produce the inventive water-absorbing polymer structures. In these processes, an aqueous, partly neutralized solution of the monomers (α1) and (α2), optionally including the water-soluble polymers (α4) and assistants (α5), is dispersed with the aid of protective colloids and/or emulsifiers in a hydrophobic organic solvent, and the polymerization is initiated by means of free-radical initiators. The crosslinkers (α3) are either dissolved in the monomer solution and are metered in together with it, or else are added separately and optionally during the polymerization. Optionally, a water-soluble polymer (α4) is added as a graft base via the monomer solution, or by direct initial charging into the oil phase. Subsequently, the water is removed from the mixture as an azeotrope and the polymer is filtered off.

In addition, both in the case of solution polymerization and in the case of inverse suspension and emulsion polymerization, the crosslinking can be effected by copolymerization of the polyfunctional crosslinker (α3) dissolved in the monomer solution and/or by reaction of suitable crosslinkers with functional groups of the polymer during the polymerization steps.

The processes are described, for example, in publications U.S. Pat. No. 4,340,706, DE-A-37 13 601, DE-A-28 40 010 and WO-A-96/05234, the corresponding disclosure of which is hereby incorporated by reference.

In process step ii), the polymer gel obtained in process step i) is optionally comminuted, this comminution being effected especially when the polymerization is performed by means of a solution polymerization. The comminution can be effected by means of comminution apparatus known to those skilled in the art, for instance a meat grinder.

In process step iii), the polymer gel which has optionally been comminuted beforehand is dried. The polymer gel is preferably dried in suitable driers or ovens. Examples include rotary tube ovens, fluidized bed driers, pan driers, paddle driers or infrared driers. It is additionally preferred in accordance with the invention that the polymer gel is dried in process step iii) down to a water content of 0.5 to 25% by weight, preferably of 1 to 10% by weight, the drying temperatures typically being within a range from 100 to 200° C.

In process step iv), the water-absorbing polymer structures obtained in process step iii), especially when they have been obtained by solution polymerization, can be ground and screened off to the desired particle size specified at the outset. The dried water-absorbing polymer structures are ground preferably in suitable mechanical comminution apparatus, for example a ball mill, whereas the screening-off can be effected, for example, by using screens with suitable mesh size.

In process step v), the optionally ground and screened-off water-absorbing polymer structures are surface-modified, which surface modification preferably includes a surface postcrosslinking

For the surface postcrosslinking, the dried and optionally ground and screened-off water-absorbing polymer structures from process step iii) or iv), or else the as yet undried but preferably already comminuted polymer gel from process step ii), are contacted with a preferably organic, chemical surface postcrosslinker. Especially when the postcrosslinker is not liquid under the postcrosslinking conditions, it is preferably contacted with the water-absorbing polymer structures or the polymer gel in the form of a fluid comprising the postcrosslinker and a solvent. The solvents used are preferably water, water-miscible organic solvents, for instance methanol, ethanol, 1-propanol, 2-propanol or 1-butanol or mixtures of at least two of these solvents, water being the most preferred solvent. It is additionally preferred that the postcrosslinker is present in the fluid in an amount within a range from 5 to 75% by weight, more preferably 10 to 50% by weight and most preferably 15 to 40% by weight, based on the total weight of the fluid.

The contacting of the water-absorbing polymer structure or of the optionally comminuted polymer gel with the fluid including the postcrosslinker is effected preferably by good mixing of the fluid with the polymer structure or the polymer gel.

Suitable mixing units for applying the fluid are, for example, the PattersonKelley mixer, DRAIS turbulent mixers, Lodige mixers, Ruberg mixers, screw mixers, pan mixers and fluidized bed mixers, and also continuous vertical mixers in which the polymer structure is mixed at high frequency by means of rotating blades (Schugi mixer).

The polymer structure or the polymer gel is contacted in the course of postcrosslinking preferably with at most 20% by weight, more preferably with at most 15% by weight, further preferably with at most 10% by weight, even further preferably with at most 5% by weight, of solvent, preferably water.

In the case of polymer structures in the form of preferably spherical particles, it is additionally preferred in accordance with the invention that the contacting is effected in such a way that only the outer region but not the inner region of the particulate polymer structures is contacted with the fluid and hence the postcrosslinker.

Postcrosslinkers are preferably understood to mean compounds which have at least two functional groups which can react with functional groups of a polymer structure in a condensation reaction (=condensation crosslinkers), in an addition reaction or in a ring-opening reaction. Preferred post crosslinkers are those specified in WO-A-2004/037903 as crosslinkers of crosslinker classes II.

Among these compounds, particularly preferred postcrosslinkers are condensation crosslinkers, for example diethylene glycol, triethylene glycol, polyethylene glycol, glycerol, polyglycerol, propylene glycol, diethanolamine, triethanolamine, polyoxypropylene, oxyethylene-oxypropylene block copolymers, sorbitan fatty acid esters, polyoxyethylene sorbitan fatty acid esters, trimethylolpropane, pentaerythritol, polyvinyl alcohol, sorbitol, 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dio xan-2-one, 4-methyl-1,3-dioxan-2-one, 4,6-dimethyl-1,3-dioxan-2-one and 1,3-dio xo lan-2-one.

Once the polymer structures or the polymer gels have been contacted with the postcrosslinker or with the fluid including the postcrosslinker, they are heated to a temperature in the range from 50 to 300° C., preferably 75 to 275° C. and more preferably 150 to 250° C., such that, preferably as a result of which, the outer region of the polymer structures is more highly crosslinked compared to the inner region (=postcrosslinking), and, when polymer gels are used, they are simultaneously also dried. The duration of the heat treatment is limited by the risk that the desired profile of properties of the polymer structures is destroyed owing to the action of heat.

Moreover, the surface modification in process step v) may also include treatment with a compound containing aluminum, preferably Al³⁺ ions, preference being given to performing this treatment simultaneously with the surface postcrosslinking by contacting a preferably aqueous solution including the postcrosslinker and the compound including aluminum, preferably Al^{3°} ions, with the water-absorbing polymer structures and then heating.

It is preferred that the compound containing aluminum is contacted with the water-absorbing polymer structures in an amount within a range from 0.01 to 30% by weight, more preferably in an amount within a range from 0.1 to 20% by weight and further preferably in an amount within a range from 0.3 to 5% by weight, based in each case on the weight of the water-absorbing polymer structures.

Preferred aluminum-containing compounds are water-soluble compounds containing Al³⁺ ions, for instance AlCl₃×6H₂O, NaAl(SO₄)₂×12 H₂O, KAl(SO₄)₂×12 H₂O or Al₂(SO₄)₃×14-18 H₂O, aluminum lactate or else water-insoluble aluminum compounds, for instance aluminum oxides, for example Al₂O₃, or aluminates. Particular preference is given to using mixtures of aluminum lactate and aluminum sulphate.

It is thus preferred in accordance with the invention that at least one of conditions I) and II) is, or possibly also both conditions I) and II) are, met:
I) the hollow bodies with a shell of the inorganic or organic material are added to the monomers in process step i);
II) the hollow bodies with a shell of the inorganic or organic material are incorporated into the hydrogel obtained in process step i) or into the comminuted hydrogel obtained in process step ii).

In the case of use of hollow bodies with a shell of a polymeric thermoplastic material, it is conceivable in principle, according to alternative I) or II), to use already expanded polymeric thermoplastic materials, or else polymeric thermoplastic materials which are yet to be expanded (i.e. those in which the blowing agent, for example in the case of use of hydrocarbons as the blowing agent, is still in liquid form) but which expand as a result of the evolution of heat in the course of polymerization, as a result of the supply of heat during the drying or else as a result of the supply of heat during the surface postcrosslinking

In a particular embodiment of the process, with which the inventive water-absorbing polymer structures are obtainable and in which hollow bodies with a shell of a polymeric thermoplastic material are used, the hollow bodies used according to alternatives I) and II) are in the form of particles which have a mean volume V₁ and can be expanded to the mean volume V₂>V₁ by increasing the temperature, this expansion preferably being effected during at least one of process steps i) to v). In connection with such particulate, as yet unexpanded, polymeric thermoplastic materials, it is especially preferred that at least 50% by weight of these particles, even more preferably at least 75% by weight of these particles and most preferably at least 90% by weight of these particles have a particle size within a range from 0.01 to 60 μm, more preferably within a range from 1 to 50 μm and even more preferably within a range from 5 to 40 μm.

Examples of such as yet unexpanded polymeric thermoplastic materials include, for example, the EXPANCEL®551 DU 20, EXPANCEL®551 DU 40, EXPANCEL®461 DU 20, EXPANCEL®461 DU 40, EXPANCEL®051 DU 40, EXPANCEL®053 DU 40, EXPANCEL®009 DU 80, EXPANCEL®091 DU 80, EXPANCEL®091 DU 140, EXPANCEL®092 DU 80, EXPANCEL®092 DU 140, EXPANCEL®093 DU 120, EXPANCE®920 DU 40, EXPANCEL®930 DU 120, EXPANCEL®950 DU 80, EXPANCEL®950 DU 120, EXPANCEL®642 WU 40, EXPANCEL®551 WU 20, EXPANCEL®551 WU 40, EXPANCEL®551 WU 80, EXPANCEL®461 WU 20, EXPANCEL®461 WU 40, EXPANCEL®051 WU 40, EXPANCEL®007 WU 40, EXPANCEL®053 WU 40, EXPANCEL®054 WUF 40, EXPANCEL®091 WU 80 and EXPANCEL®920 WUF 40 products obtainable from Akzo Nobel. Such particulate polymeric thermoplastic materials preferably include a blowing agent which is still present at least partly in liquid form, for example a hydrocarbon still present in liquid form, which is surrounded by a shell of a polymeric thermoplastic material and at least partly evaporates in the course of heating, thus bringing about the expansion of the polymeric thermoplastic material to form a hollow body.

It is additionally preferred in accordance with the invention that the polymeric thermoplastic materials surrounding an as yet unexpanded blowing agent typically have a temperature Tₛₜₐᵣₜ (this is the temperature at which the expansion of the polymeric thermoplastic material surrounding the blowing agent commences) within a range from 40 to 180° C., more preferably within a range from 60 to 160° C. and most preferably within a range from 70 to 150° C., while the temperature Tₘₐₓ (this is the temperature at which the maximum of the expansion is attained) is preferably within a range from 100 to 240° C., more preferably within a range from 120 to 220° C. and most preferably within a range from 140 to 210° C.

In another particular embodiment of the process, with which the inventive water-absorbing polymer structures are obtainable and in which hollow bodies with a shell of a polymeric thermoplastic material are used, the hollow bodies used according to alternatives I) and II) are in the form of particles which have a mean volume V₂ and which are obtainable by virtue of the particles having been expanded to the mean volume V₂ proceeding from a mean volume V₁<V₂.

In connection with such polymeric thermoplastic materials which have already been expanded when used, it is preferred that at least 50% by weight of these particles, even more preferably at least 75% by weight of these particles and most preferably at least 90% by weight of these particles have a particle size within a range from 20 to 100 μm and most preferably within a range from 30 to 60 μm.

Examples of such already expanded, particulate, polymeric thermoplastic materials include, for example, the EXPANCEL®WE and EXPANCEL®DE products obtainable from Akzo Nobel. Such polymeric thermoplastic materials preferably comprise a blowing agent already present at least partly in gaseous form, for example a hydrocarbon already present at least partly in gaseous form, which is surrounded by a shell of a polymeric thermoplastic material.

In a further particular embodiment of the process, with which the inventive water-absorbing polymer structures are obtainable and in which hollow bodies with a shell of a polymeric non-thermoplastic material are used, these polymeric non-thermoplastic materials are likewise in the form of preferably spherical particles, it being preferred that at least 50% by weight of these particles, even more preferably at least 75% by weight of these particles and most preferably at least 90% by weight of these particles have a diameter within a range from 10 nm to 100 μm, more preferably within a range from 25 nm to 50 μm and most preferably within a range from 50 nm to 30 μm.

When the hollow bodies with a shell of the inorganic or organic material are added to the monomer solution according to alternative I), they can be stirred directly into the monomer solution. However, it is also conceivable to first disperse them in a small volume of a solvent, for example water, and then to add this dispersion to the monomer solution. Hollow bodies, for instance the ROPAQUE® products obtainable from Rohm & Haas, are already present in the form of emulsion and can optionally be added to the monomer solution already in the form of this emulsion. When the hollow bodies with a shell of the inorganic or organic material are incorporated into the hydrogel or the comminuted hydrogel according to alternative II), these hollow bodies are incorporated in the gel by means of suitable kneading apparatus directly or after predispersion in a solvent, for example water.

In a particular embodiment of the inventive water-absorbing polymer structures, they have an absorption rate determined by the test method described herein of at least 0.30 g/g/sec, even more preferably of at least 0.35 g/g/sec and most preferably of at least 0.40 g/g/sec, preference being given to not exceeding an absorption rate of 1.0 g/g/sec and even more preferably of 0.6 g/g/sec.

Furthermore, it is preferred in accordance with the invention that the water-absorbing polymer structures have at least one of the following properties:
(β1) an absorption under a pressure of 50 g/cm² determined by the test method described herein of at least 22.0 g/g, preferably of at least 23.5 g/g and most preferably of 24 g/g, preferably not exceeding a value of 28 g/g, even more preferably of 27 g/g and most preferably of 26 g/g;
(β2) a retention determined by the test method described herein of at least 26 g/g, preferably of at least 26.5 g/g and most preferably of 27 g/g, preferably not exceeding a value of 36 g/g, even more preferably of 34 g/g and most preferably of 32 g/g;
(β3) a permeability determined by the test method described herein of at least 45×10⁻⁷ cm³ sec/g, preferably of at least 75×10⁻⁷ cm³ sec/g and most preferably of at least 100×10⁻⁷ cm³ sec/g, preferably not exceeding a value of 190×10⁻⁷ cm³ sec/g, even more preferably of 170×10⁻⁷ cm³ sec/g and most preferably of 150×10⁻⁷ cm³ sec/g.

Water-absorbing polymer structures particularly preferred in accordance with the invention are those which preferably have, in addition to the above-described advantageous absorption rate, the following properties or combinations of properties: (β1), (β2), (β3), (β1) (β2), (β1) (β3), (β2) (β3), (β1) (β2) (β3).

A contribution to the achievement of the objects cited at the outset is additionally made by a process for producing water-absorbing polymer structures, comprising the process steps of:
i) free-radically polymerizing an aqueous monomer solution comprising a polymerizable, monoethylenically unsaturated monomer bearing an acid group (α1) or a salt thereof, optionally a monoethylenically unsaturated monomer (α2) polymerizable with monomer (α1), and optionally a crosslinker (α3), to obtain a polymer gel;
ii) optionally comminuting the hydrogel;
iii) drying the optionally comminuted hydrogel to obtain water-absorbing polymer particles;
iv) optionally grinding and screening off the water-absorbing polymer particles thus obtained;
v) optionally further surface modifying the water-absorbing polymer particles thus obtained;
   where at least one of conditions I) and II) is, and possibly also both conditions I) and II) are, met:
I) hollow bodies with a shell of an inorganic or organic material are added to the monomers in process step i);
II) hollow bodies with a shell of an inorganic or organic material are incorporated into the hydrogel obtained in process step i) or into the comminuted hydrogel obtained in process step ii).

With regard to process steps i) to v) and alternatives (I) and (II), reference is made to the above remarks with regard to the inventive water-absorbing polymer structures.

Also in connection with the process according to the invention for producing water-absorbing polymer structures, it is therefore conceivable in the case of use of hollow bodies with a shell of a polymeric thermoplastic material, according to alternative I) or II), to use already expanded polymeric thermoplastic materials, or else as yet unexpanded polymeric thermoplastic materials.

In a preferred embodiment of the process according to the invention, in which hollow bodies with a shell of a polymeric thermoplastic material are used, the hollow bodies used according to alternatives I) and II) are in the form of particles which have a mean volume V₁ and can be expanded to the mean volume V₂>V₁ by increasing the temperature, this expansion preferably being effected during at least one of process steps i) to v). With regard to the preferred particle size of such as yet unexpanded materials and with regard to specific examples of suitable materials, reference is made to the above remarks in connection with the inventive water-absorbing materials.

In another particular embodiment of the process according to the invention, in which hollow bodies with a shell of a polymeric thermoplastic material are used, the hollow bodies used according to alternatives I) and II) are in the form of particles which have a mean volume V₂ and which are obtainable by virtue of the particles having been expanded to the mean volume V₂ proceeding from a mean volume V₁<V₂. Here too, with regard to the preferred particle size of such already expanded materials and with regard to specific examples of suitable materials, reference is made to the above remarks in connection with the inventive water-absorbing materials.

It is additionally preferred that the hollow bodies with a shell of an inorganic or organic material are used in an amount within a range from 0.001 to 15% by weight, more preferably within a range from 0.01 to 7.5% by weight and most preferably within a range from 0.1 to 3% by weight.

A contribution to the achievement of the objects cited at the outset is also made by the water-absorbing polymer structures obtainable by the above-described process.

A further contribution to the achievement of the objects described at the outset is made by a composite comprising the inventive water-absorbing polymer structures or the water-absorbing polymer structures obtainable by the process according to the invention and a substrate. It is preferred that the inventive polymer structures and the substrate are bonded to one another in a fixed manner. Preferred substrates are polymer films, for example of polyethylene, polypropylene or polyamide, metals, nonwovens, fluff, tissues, wovens, natural or synthetic fibers, or other foams. It is additionally preferred in accordance with the invention that the composite comprises at least one region which includes the inventive water-absorbing polymer structure in an amount in the range from about 15 to 100% by weight, preferably about 30 to 100% by weight, more preferably from about 50 to 99.99% by weight, further preferably from about 60 to 99.99% by weight and even further preferably from about 70 to 99% by weight, based in each case on the total weight of the region of the composite in question, which region preferably has a size of at least 0.01 cm³, preferably at least 0.1 cm³ and most preferably at least 0.5 cm³.

A particularly preferred embodiment of the inventive composite involves a flat composite as described in WO-A-02/056812 as an “absorbent material”. The disclosure of WO-A-02/056812, especially with regard to the exact structure of the composite, the basis weight of its constituents and its thickness, is hereby incorporated by reference and constitutes part of the disclosure of the present invention.

A further contribution to the achievement of the objects cited at the outset is provided by a process for producing a composite, wherein the inventive water-absorbing polymer structures or the water-absorbing polymer structures obtainable by the process according to the invention and a substrate and optionally an additive are contacted with one another. The substrates used are preferably those substrates which have already been mentioned above in connection with the inventive composite.

A contribution to the achievement of the objects cited at the outset is also made by a composite obtainable by the process described above, which composite preferably has the same properties as the above-described inventive composite.

A further contribution to the achievement of the objects cited at the outset is made by chemical products comprising the inventive polymer structures or an inventive composite. Preferred chemical products are especially foams, moldings, fibers, foils, films, cables, sealing materials, liquid-absorbing hygiene articles, especially diapers and sanitary napkins, carriers for plant growth- or fungal growth-regulating compositions or active crop protection ingredients, additives for building materials, packaging materials or soil additives.

The use of the inventive polymer structures or of the inventive composite in chemical products, preferably in the aforementioned chemical products, especially in hygiene articles such as diapers or sanitary napkins, and the use of the superabsorbent particles as carriers for plant growth- or fungal growth-regulating compositions or active crop protection ingredients, also makes a contribution to the achievement of the objects cited at the outset. In the case of use as a carrier for plant growth- or fungal growth-regulating compositions or active crop protection ingredients, it is preferred that the plant growth- or fungal growth-regulating compositions or active crop protection ingredients can be released over a period controlled by the carrier.

A further contribution to the achievement of the objects cited at the outset is made by the use of hollow bodies with a shell of an inorganic or organic material for producing water-absorbing polymer structures. Particular preference is given in this context to the use of those hollow bodies which have already been specified at the outset as preferred hollow bodies in connection with the inventive water-absorbing polymer structures.

The invention is now illustrated in detail with reference to figures, test methods and non-limiting examples.

### Test Methods

### Determination of Absorption Rate

The absorption rate was determined via the measurement of the “Free Swell Rate—FSR” according to the test method described in EP-A-0 443 627 on page 12.

### Determination of Absorption Under Pressure

The absorption under a pressure of 0.7 psi (about 50 g/cm²), designated “AAP”, is determined to ERT 442.2-02, “ERT” standing for “EDANA recommended Test” and “EDANA” for “European Disposables and Nonwovens Association”.

### Determination of Retention

The retention, designated “CRC”, is determined to ERT 441.2-02.

### Determination of Permeability

The permeability was determined by measuring the “Saline Flow Conductivity—SFC” by the test method described in WO-A-95/26209.

### EXAMPLES

### Comparative Example

A monomer solution consisting of 320 g of acrylic acid, 248.649 g of NaOH (50%), 407.022 g of deionized water, 0.631 g of polyethylene glycol-300 diacrylate (with a content of active substance of 76.1% by weight) and 1.31 g of polyethylene glyco 1-500 O-monoallyl ether acrylate (with a content of active substance of 73.1% by weight) was freed of dissolved oxygen by purging with nitrogen and cooled to the start temperature of 4° C. On attainment of the start temperature, the initiator solution (0.3 g of sodium peroxydisulphate in 10.0 g of H₂O, 0.07 g of 35% hydrogen peroxide solution in 10.0 g of H₂O and 0.015 g of ascorbic acid in 2.0 g of H₂O) was added. Once the end temperature of about 110° C. had been attained, the resulting gel was comminuted with a meat grinder and dried in a drying cabinet at 150° C. for 2 hours. The dried polymer was crushed coarsely, ground with a 2 mm screen by means of an SM 100 knife mill and screened to a powder with a particle size of 150 to 710 μm (=powder A).

Powder A was mixed in a laboratory mixer with an aqueous solution consisting of ethylene carbonate (1% by weight based on powder A), aluminum lactate (0.3% by weight based on powder A), aluminum sulphate (0.3% by weight based on powder A) and water (3% by weight based on powder A), and then heated at 170° C. in an oven for 90 min (=non-inventive powder A).

### Example 1

Comparative Example 1 is repeated, except that 0.25% by weight (based on the total weight of the monomer solution) of EXPANCEL®930 DU 120 particles which had been predispersed in 50 ml of water is added to the monomer solution. The inventive powder B was obtained.

### Example 2

Comparative Example 1 is repeated, except that 0.5% by weight (based on the total weight of the monomer solution) of EXPANCEL®930 DU 120 particles which had been predispersed in 50 ml of water is added to the monomer solution. The inventive powder C was obtained.

### Example 3

Comparative Example 1 is repeated, except that 0.5% by weight (based on the total weight of the monomer solution) of EXPANCEL®091 WU 80 particles which had been predispersed in 50 ml of water is added to the monomer solution. The inventive powder D was obtained.

The powders A to D obtained above were characterized by the following properties:

| | AAP_{0.7 psi} | CRC | SFC | FSR |
|---|---|---|---|---|
| Powder | [g/g] | [g/g] | [×10⁻⁷ cm³sec/g] | [g/g/sec] |
| A | 23.5 | 27.3 | 115 | 0.20 |
| B | 23.3 | 26.7 | 87 | 0.38 |
| C | 23.1 | 26.3 | 90 | 0.37 |
| D | 23.2 | 26.9 | 105 | 0.40 |

It can be inferred from the results in the table above that the use of the EXPANCEL® particles can significantly improve the absorption rate (FSR) without a crucial deterioration in the remaining absorption properties (AAP_{0.7psi}, CRC and SFC).

1. Water-absorbing polymer structures comprising hollow bodies comprising a shell of an inorganic or organic material.

2. The water-absorbing polymer structures according to claim 1, wherein the water-absorbing polymer structures are based on partly neutralized, crosslinked acrylic acid.

3. The water-absorbing polymer structures according to claim 1, wherein at least some of the hollow bodies are embedded in the water-absorbing polymer structure configured as a matrix.

4. The water-absorbing polymer structures according to claim 1, wherein the hollow bodies are distributed homogeneously in the water-absorbing polymer structures.

5. The water-absorbing polymer structures according to claim 1, wherein the water-absorbing polymer structures comprise the hollow bodies in an amount within a range from 0.001 to 15% by weight, based on the total weight of the water-absorbing polymer structures.

6. The water-absorbing polymer structures according to claim 1, wherein the water-absorbing polymer structures are obtainable by a process comprising the process steps of:
i) free-radically polymerizing an aqueous monomer solution comprising a polymerizable, monoethylenically unsaturated monomer bearing an acid group (α1) or a salt thereof, optionally a monoethylenically unsaturated monomer (α2) polymerizable with monomer (α1), and optionally a crosslinker (α3), to obtain a hydrogel;
ii) optionally comminuting the hydrogel;
iii) drying the hydrogel to obtain water-absorbing polymer particles;
iv) optionally grinding and screening the water-absorbing polymer particles thus obtained to a mean particle size in the range of from 10 to 3000 μm; and
v) optionally further surface modifying the water-absorbing polymer particles thus obtained;
where at least one of conditions I) and II) is met:
I) the hollow bodies are added to the monomers in process step i); and/or
II) the hollow bodies are incorporated into the hydrogel obtained in process step i) or into the comminuted hydrogel obtained in process step ii).

7. The water-absorbing polymer structures according to claim 6, wherein the organic material is a polymeric thermoplastic material which includes a blowing agent.

8. The water-absorbing polymer structures according to claim 7, wherein the hollow bodies are in the form of particles which have a mean volume V₁ and can be expanded to the mean volume V₂>V₁ by increasing the temperature during at least one of the process steps i) to v).

9. The water-absorbing polymer structures according to claim 8, wherein the particles are expanded during at least one of process steps i) to v).

10. The water-absorbing polymer structures according to claim 7, wherein the hollow bodies are in the form of particles which have a mean volume V₂; wherein said particles were expanded to the mean volume V₂ from a mean volume V₁<V₂.

11. The water-absorbing polymer structures according to claim 1, wherein the organic material is a polymeric non-thermoplastic material.

12. The water-absorbing polymer structures according to claim 1, wherein the inorganic material is a polycrystalline aluminum oxide.

13. The water-absorbing polymer structures according to claim 1, having an absorption rate determined by the Free Swell Rate Test of at least 0.3 g/g/sec.

14. The water-absorbing polymer structures according to claim 1, which have at least one of the following properties:
(β1) an absorption under a pressure of 50 g/cm², determined by the European Disposables and Nonwovens Association Recommended Test (“ERT”) 442.2-02, of at least 22.0 g/g;
(β2) a retention determined by ERT 441.2-02 of at least 26 g/g;
(β3) a permeability determined by the Saline Flow Conductivity Test of at least 45×10⁻⁷ cm³ sec/g.

15. A process for producing water-absorbing polymer structures, comprising the process steps of:
i) free-radically polymerizing an aqueous monomer solution comprising a polymerizable, monoethylenically unsaturated monomer bearing an acid group (α1) or a salt thereof, optionally a monoethylenically unsaturated monomer (α2) polymerizable with monomer (α1), and optionally a crosslinker (α3), to obtain a hydrogel;
ii) optionally comminuting the hydrogel;
iii) drying the hydrogel to obtain water-absorbing polymer particles;
iv) optionally grinding and screening the water-absorbing polymer particles thus obtained to a mean particle size in the range of from 10 to 3000 μm; and
v) optionally further surface modifying the water-absorbing polymer particles thus obtained;
where at least one of conditions I) and II) is met:
I) hollow bodies with a shell of an inorganic or organic material are added to the monomers in process step i); and/or
II) hollow bodies with a shell of an inorganic or organic material are incorporated into the hydrogel obtained in process step i) or into the comminuted hydrogel obtained in process step ii).

16. The process according to claim 15, wherein the organic material is a polymeric thermoplastic material which includes a blowing agent, and wherein the hollow bodies are in the form of particles which have a mean volume V₁ and can be expanded to the mean volume V₂>V₁ by increasing the temperature during at least one of process steps i) to v).

17. The process according to claim 16, wherein the particles are expanded during at least one of process steps i) to v).

18. The process according to claim 15, wherein the organic material is a polymeric thermoplastic material which includes a blowing agent, and wherein the hollow bodies are in the form of particles which have a mean volume V₂ wherein said particles were expanded to the mean volume V₂ from a mean volume V₁<V₂.

19. The process according to claim 15, wherein the polymeric material is a polymeric non-thermoplastic material.

20. The process according to claim 15, wherein the inorganic material is a polycrystalline aluminum oxide.

21. Water-absorbing polymer structures obtainable by the process according to claim 15.

22. The water-absorbing polymer structures according to claim 21, which have an absorption rate determined by the Free Swell Rate Test of at least 0.3 g/g/sec.

23. The water-absorbing polymer structures according to claim 21, which have at least one of the following properties:
(β1) an absorption under a pressure of 50 g/cm² determined by the European Disposables and Nonwovens Association Recommended Test (“ERT”) 442.2-02 of at least 22.0 g/g;
(β2) a retention determined by ERT 441.2-02 of at least 26 g/g;
(β3) a permeability determined by the Saline Flow Conductivity Test of at least 45×10⁻⁷ g/cm³ sec/g.

24. A composite comprising water-absorbing polymer structures according to claim 13 and a substrate.

25. A process for producing a composite, wherein water-absorbing polymer structures according to claim 14 and a substrate and optionally an assistant are contacted with one another.

26. A composite obtainable by a process according to claim 25.

27. Foams, moldings, fibers, foils, films, cables, sealing materials, liquid-absorbing hygiene articles, carriers for plant growth- and fungal growth-regulating compositions, packaging materials, soil additives or building materials, comprising water-absorbing polymer structures according to claim 14.

28. Use of the water-absorbing polymer structures according to claim 14 in foams, moldings, fibers, foils, films, cables, sealing materials, liquid-absorbing hygiene articles, carriers for plant growth- and fungal growth-regulating compositions, packaging materials, soil additives, for controlled release of active ingredients or in building materials.

29. (canceled)
